(19) United States
(12) Patent Application Publication
(10) Pub. No.: US 2025/0138630 A1
(43) Pub. Date: May 1, 2025

(54) Gaze-depth Interaction in Virtual, Augmented, or Mixed Reality

(71) Applicant: The Board of Trustees of the University of Illinois, Urbana, IL (US)

(72) Inventors: Elaheh Soltanaghaei Koupaei, Champaign, IL (US); Eric Gene Shaffer, Urbana, IL (US); Chenyang Zhang, Urbana, IL (US); Tiansu Chen, Urbana, IL (US)

(21) Appl. No.: 18/929,086

(22) Filed: Oct. 28, 2024

Related U.S. Application Data
(60) Provisional application No. 63/617,821, filed on Jan. 5, 2024.
(60) Provisional application No. 63/546,199, filed on Oct. 28, 2023.

(51) Int. Cl. G06F 3/01

(52) U.S. Cl. CPC G06F 3/013

(57) ABSTRACT

The disclosure includes systems and methods for performing gaze-daze-based interaction in virtual reality and mixed reality (XR) environments. An example system includes at least one head-mountable display (HMD) with at least one eye-tracking sensor, and an XR environment with at least one virtual window with a respective level of visual transparency that is responsive to the characteristic gaze depth calculated by the system. The characteristic gaze depth is calculated based on the eye tracking data, and may utilize a noise-reduction model. An example method of creating an XR training environment for users is also disclosed.

### CROSS-REFERENCE TO RELATED APPLICATIONS

This application claims priority to U.S. Patent Application No. 63/617,821 filed Jan. 5, 2024 and U.S. Patent Application No. 63/546,199 filed Oct. 28, 2023, the contents of both of which are incorporated herein by reference in their entirety.

### BACKGROUND

Gaze interaction has gained popularity as an input method for 3D interaction in virtual reality and mixed reality (collectively known as XR) headsets where the eye movements and gestures would be used as an input. Current gaze-based XR interaction methods often rely on gaze as a means of pointing. However, these works primarily utilize the direction of gaze and overlook the valuable gaze depth information, representing an additional free input dimension along the z-axis. Accordingly, there exists a need for systems and methods that better utilize gaze depth information in XR interactions.

### SUMMARY

Embodiments of the present disclosure include systems and methods for visual depth detection, noise reduction, and the use of visual depth input data for a virtual-window-based user interface. In certain embodiments, the use of a noise reduction algorithm to reduce the amount of variation caused by voluntary, reflexive, or random saccades, providing the ability to calculate a characteristic gaze depth for a user. Certain embodiments simultaneously provide the ability to improve the noise-reduction algorithm through machine learning techniques. In some embodiments, a graphical user interface for an XR environment configured to display windows with multiple respective levels of visual transparency and responsive to the characteristic gaze depth of a user is provided. Further embodiments include methods that implement a training module or training program utilizing various visual aids to teach users to utilize their characteristic gaze depth to interact with the graphical user interface.

In a first aspect, a system for calculating a characteristic gaze depth is provided. The system includes a head-mountable display (HMD). The head-mountable display includes at least one eye-tracking sensor that can record data such as gaze dwell time, blink detection, gaze direction, and gaze convergence. The system also includes at least one controller with a memory. The system also includes a graphical user interface with at least one virtual window with a respective level of visual transparency and responsive to the characteristic gaze depth.

In a second aspect, a method for interacting with an XR environment based on the calculated characteristic gaze depth is provided. The method includes displaying, by the HMD, an XR environment, wherein the XR environment comprises a plurality of virtual windows with respective levels of visual transparency that are displayed at respective virtual distances in the XR environment. The method further includes receiving, from eye-tracking sensors of the HMD, eye tracking data, processing these data with a noise-reduction model, and then using that processed eye-tracking data to calculate a characteristic gaze depth. The characteristic gaze depth is used to select at least one virtual window in the XR environment, adjust a position of the at least one virtual window, or adjust the transparency of the at least one virtual window.

In a third aspect, a method of creating a training environment or procedure for users in the XR environment is provided. The training environment includes displaying, by the HMD, an XR training environment, wherein the XR training environment comprises a plurality of virtual windows with respective levels of visual transparency, and wherein each of the virtual windows in the plurality of virtual windows comprises a visual cue of a differing visual transparency. A set of pre-determined training tasks over a pre-determined time period is then provided to the XR training environment. Each pre-determined training task may include displaying one or more virtual windows with a visual cue that is activated when the characteristic gaze depth indicate that the visual cue is being focused on. Further embodiments may include adjusting the visual cues of the virtual windows based on past user performance.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE FIGURES

FIG. 1 illustrates an overview of the system to calculate a characteristic gaze depth, according to an example embodiment.

FIG. 2 illustrates an overview of a graphical user interface based on one or more windows with varying respective levels of visual transparency and responsive to the characteristic gaze depth, according to an example embodiment.

FIG. 3 illustrates an overview of using the characteristic gaze depth and eye-tracking data to interact with the graphical user interface based on one or more windows with varying respective levels of visual transparency, according to an example embodiment.

FIG. 4 illustrates another overview of using the characteristic gaze depth and eye-tracking data to interact with the graphical user interface based on one or more windows with varying respective levels of visual transparency, according to an example embodiment.

FIG. 5 illustrates an example overview of a virtual window that may be within the graphical user interface based on one or more windows with varying respective levels of visual transparency and responsive to the characteristic gaze depth, according to an example embodiment.

FIG. 6 illustrates another example overview of a virtual window that may be within the graphical user interface based on one or more windows with varying respective levels of visual transparency and responsive to the characteristic gaze depth, according to an example embodiment.

FIG. 7 illustrates another example overview of a virtual window that may be within the graphical user interface based on one or more windows with varying respective levels of visual transparency and responsive to the characteristic gaze depth, according to an example embodiment.

FIG. 8 illustrates an example method of calculating a characteristic gaze depth and facilitating interactions with the XR environment using the characteristic gaze depth, according to example embodiments.

FIG. 9 illustrates an example method for training a user to use the characteristic gaze depth within the XR environment, according to example embodiments.

### DETAILED DESCRIPTION

Examples of methods and systems are described herein. It should be understood that the words “exemplary,” “example,” and “illustrative,” are used herein to mean “serving as an example, instance, or illustration.” Any embodiment or feature described herein as “exemplary,” “example,” or “illustrative,” is not necessarily to be construed as preferred or advantageous over other embodiments or features. Further, the exemplary embodiments described herein are not meant to be limiting. It will be readily understood that certain aspects of the disclosed systems and methods can be arranged and combined in a wide variety of different configurations.

It should be understood that the below embodiments, and other embodiments described herein, are provided for explanatory purposes, and are not intended to be limiting.

### I. OVERVIEW

Systems and methods for visual depth detection, noise reduction, and the use of visual depth input data for a virtual-window-based user interface are disclosed within. Further, a method disclosing a learning procedure with in-stage visual cues to help users adapt to the depth-control is disclosed within. As an example, the present application describes systems and methods of using eye-tracking data, such as gaze position data, to facilitate user interface interactions within a VR or MR (collectively referred to as XR) environment. The systems and methods relate to two main concepts: first, eye-tracking data is received from a head-mountable display (HMD), processed by various noise-reduction models, and used to calculate a characteristic gaze depth; and secondly, the gaze depth data is used to allow users to interact with a graphical user interface in a VR or MR environment based on multiple transparent windows that become more opaque when selected (e.g., focused/gazed upon).

The gaze depth data is calculated using various data from eye-tracking sensors of an HMD, which may include, but are not limited to, gaze position data and dwell time. The characteristic gaze depth data for a user represents the point or set of points around which the focus of the user's eyes is located over a given time interval. As human eyes may dart around quickly (e.g., voluntary, reflexive, and/or random saccades), and may not focus at one specific gaze depth for a long period of time, calculating the characteristic gaze depth data may include using a noise reduction algorithm to reduce the amount of variation in the measured eye-tracking data. Such algorithms may utilize machine learning, statistical, or probabilistic noise reduction techniques, and may be trained or customized based on a particular user and/or system settings.

In some examples, a user can interact with a virtual environment in VR or MR based on actively controlling the gaze depth. In such scenarios, the interactive user interface may include a graphical user interface configured to display windows with multiple respective levels of visual transparency. When a user fixes their gaze on a given window, or on a specific point on the window, the respective visual transparency of the window may change. This allows the user to focus on a given window to increase its respective level of visual opacity or transparency, which can allow the user to interact with elements of that window while other windows, which may be overlapping the window that the user is focusing on, could be nearly transparent or that may become more transparent.

In example embodiments, a gaze-based graphical user interface may include a training module or training program. For instance, the system or method may include a training program with strong and weak visual aids. The strong and weak visual aids may be configured to train users to more easily and quickly focus their eyes on specific points in space with more accuracy, and therefore utilize the gaze depth activated windows more effectively. In the training program, one or more of windows may initially feature a strong visual cue for the user to focus on, such as a brightly-colored target in the center of the window. By completing pre-determined tasks that involve the user focusing on certain windows at certain locations within the 3D environment, the training program may replace the strong visual cues with weak visual cues, such as a thin colored outline for the transparent windows. This further trains the user to focus on the transparent windows, allowing users to achieve proficiency in using gaze depth to interact with the graphical user interface.

### II. EXAMPLE SYSTEMS

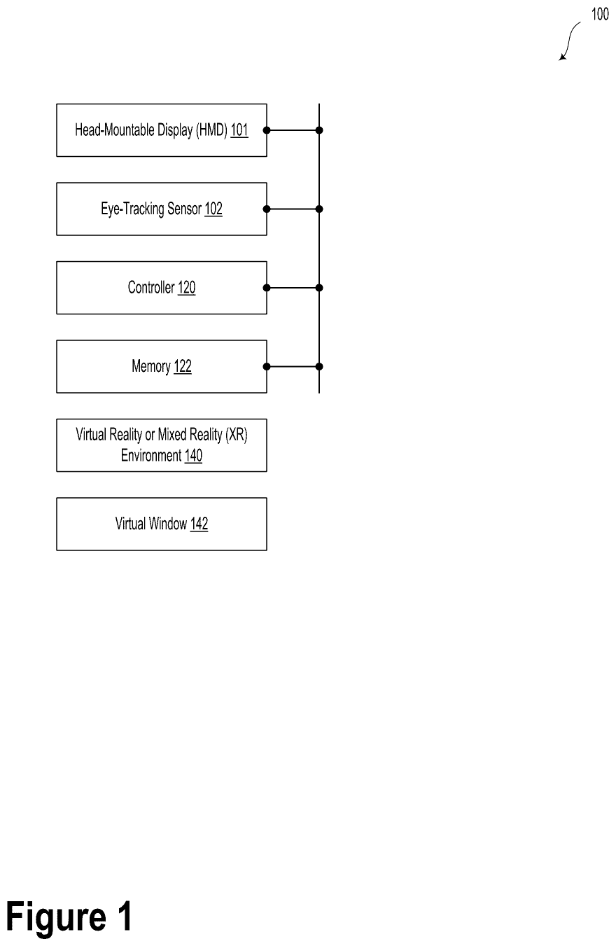

FIG. 1 illustrates an overview of the system 100 for calculating a characteristic gaze depth to facilitate interaction in an XR environment, according to an example embodiment. FIG. 1 illustrates a Head-Mountable Display (HMD) 101, which may be one of various off-the-shelf HMDs or a custom-designed unit. Further, the HMD 101 may be a VR headset, a mixed-reality (MR) headset, or another type of HMD for displaying a virtual environment to a user. The HMD 101 may include at least one eye-tracking sensor 102, which is capable of tracking the gaze direction of the user's eye. The eye-tracking sensor 102 may also record data such as eye gaze dwell time, iris constriction, eyelid openness, and gaze convergence. The system also has a controller 120 and a memory 122 which may be located within the HMD 101 or in a separate computing system that is connected physically or over a wireless network to the HMD 101. The controller 120 and the memory 122 can be configured to perform instructions that display a virtual reality or mixed reality (XR) environment 140 through the HMD 101. The XR environment 140 can be configured to display one or more virtual windows 142, wherein each virtual window has a respective level of visual transparency and is responsive to the characteristic gaze depth data. A virtual window 142 may contain content with a modifiable layout, and it may overlap other virtual windows 142 in the three-dimensional space of the XR environment 140.

In some embodiments, the controller 120 can be configured to perform operations stored on the memory 122 that calculate a characteristic gaze depth data based on the eye tracking data provided by the at least one eye-tracking sensor 102. First, the system displays, via the HMD 101, the XR environment 140, wherein the XR environment 140 comprises a plurality of virtual windows 142 with respective levels of visual transparency that are displayed at respective virtual distances in the XR environment 140. Then, the system receives, from the one or more eye-tracking sensors 102 of the HMD 101, eye-tracking data during a time interval. A noise-reduction model is applied to the eye-tracking data so as to provide processed eye tracking data, which is then used to determine, based on the processed eye-tracking data, a characteristic gaze depth during the time interval. Based on the characteristic gaze depth and the eye-tracking data during the time interval, the system then performs at least one of: selecting at least one virtual window 142, adjusting a position of the at least one virtual window 142, or adjusting the visual transparency of the at least one virtual window 142.

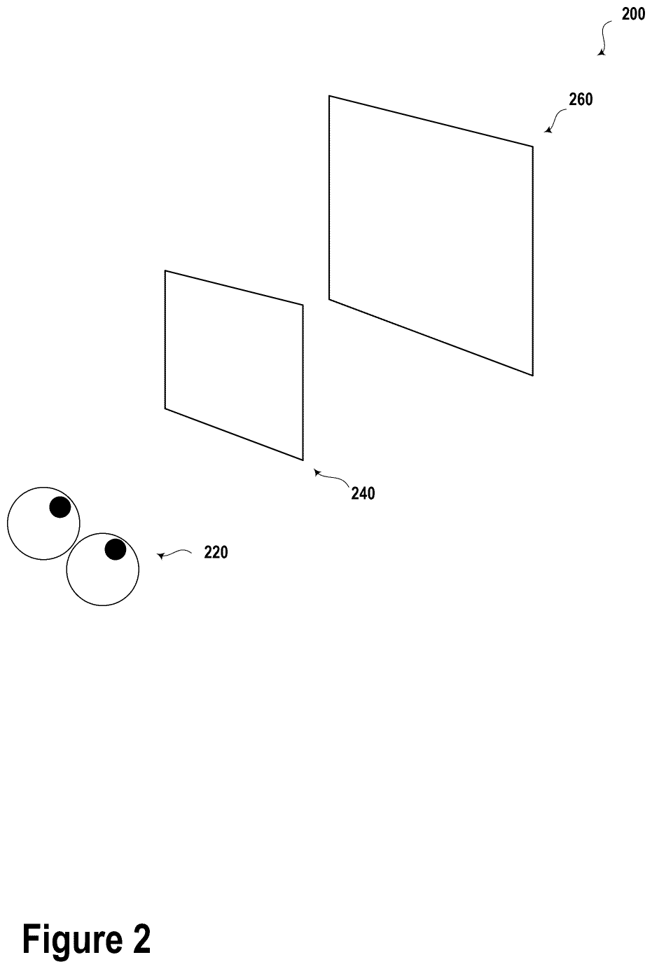

FIG. 2 illustrates an overview of graphical user interface 200 based on one or more virtual windows 240 and 260 with varying respective levels of visual transparency and responsive to the characteristic gaze depth, according to an example embodiment. In FIG. 2, eye-tracking data is collected from the user's eyes 220. In this example embodiment, the characteristic gaze depth may not have been calculated, or it may not be placed on either window 240 or window 260. Therefore, the virtual windows 240 and 260 maintain their current respective level of visual transparency. This level of transparency may vary from completely transparent, allowing the user to see through the virtual window, to completely opaque.

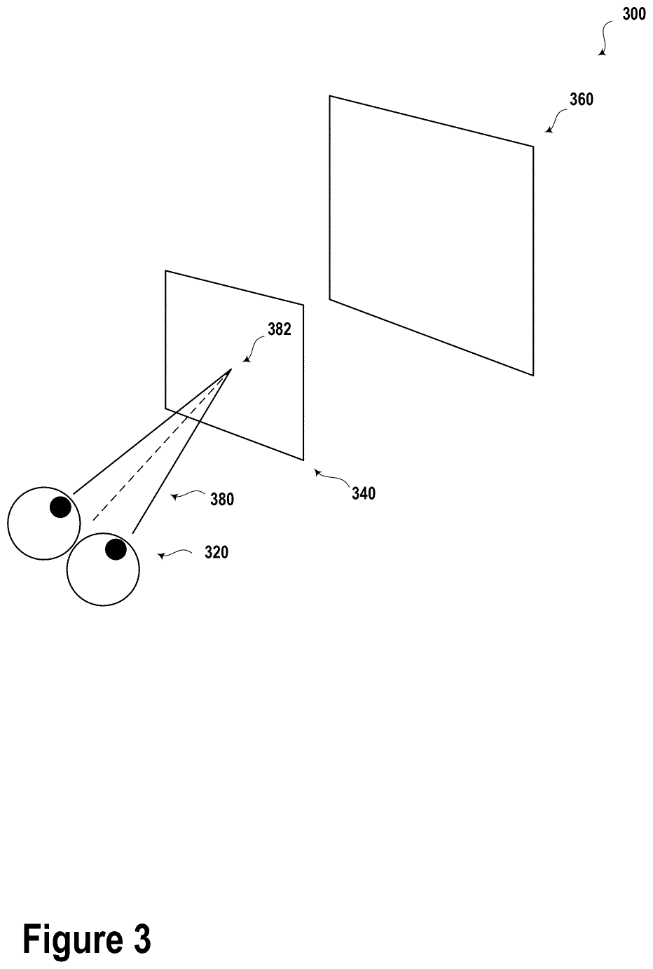

FIG. 3 illustrates an overview of using the characteristic gaze depth and eye-tracking data to interact with the graphical user interface based on one or more windows with varying respective levels of visual transparency, according to an example embodiment. In this example embodiment, eye-tracking data is collected from the user's eyes 320. The eye-tracking data may include one or more gaze direction vectors 380 that represent the gaze direction of an eye 320. Other data, such as dwell time, iris constriction, eye convergence, and eyelid openness may be collected from the user's eyes 320. The point where the one or more gaze direction vectors 380 intersect over a certain time interval may be defined as the characteristic gaze depth 382. This characteristic gaze depth 382 may further defined through a noise-reduction model, which may utilize machine learning or probabilistic methods. The characteristic gaze depth 382 is placed within the virtual window 340, which then may change its respective level of visual transparency, its layout, or another characteristic based on being selected by the characteristic gaze depth 382.

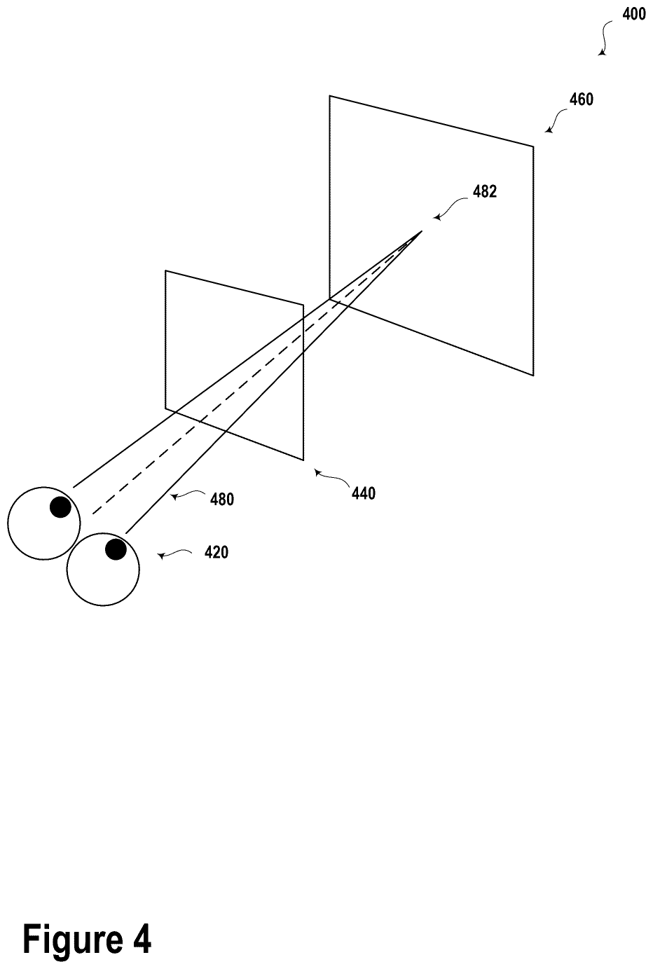

FIG. 4 illustrates an overview of using the characteristic gaze depth and eye-tracking data to interact with the graphical user interface based on one or more windows with varying respective levels of visual transparency, according to an example embodiment. In this example embodiment, eye-tracking data is collected from the user's eyes 420. Similar to the example embodiment illustrated in FIG. 3, the characteristic gaze depth 482 is determined from the eye-tracking data. The virtual window 460, which overlaps the virtual window 440 in three-dimensional space, may be selected based on the characteristic gaze depth 482, thereby changing its respective level of visual transparency, its layout, or another characteristic.

The data collected by the one or more eye-tracking sensors may include vectors that represent binocular gaze rays for each of the user's eyes. It may be assumed that the intersection point of these rays represents the characteristic gaze depth of the user, and therefore the point that their gaze is focused on. However, the rays may not necessarily all intersect at the same point in three-dimensional space in the XR environment. The system may therefore project the rays onto a two-dimensional plane, with the axes defined by the origin points of the rays. As such, the distance between the eye line and the intersection point in the projection plane is equal to the visual depth, ensuring intersection. A moving average technique over a certain pre-determined time window may also be used to filter out high-frequency variations in the eye-tracking data.

In some embodiments, the system may collect data including, but not limited to: gaze dwell time, gaze position data, eye convergence, blink detection, eyelid openness, verbal commands, or physical controllers. These data may be used to determine the characteristic gaze depth or to facilitate interactions within the graphical user interface.

In some embodiments, the systems described in FIG. 1, FIG. 2, FIG. 3, and FIG. 4 may allow for the user to modify a shape, position, contents, or other characteristics of the at least one virtual window in the graphical user interface based on the characteristic gaze depth and the gaze position data. An example embodiment may include a user selecting the at least one virtual window in the graphical user interface and changing the position of the window based on gaze dwell time, gaze position, gaze convergence, characteristic gaze depth, or other data.

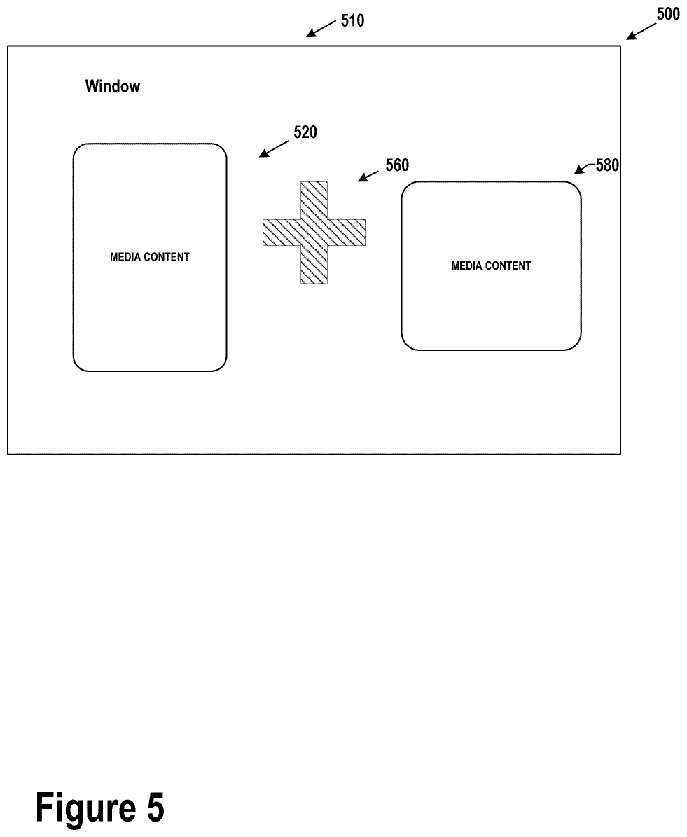

FIG. 5 illustrates an example embodiment of a virtual window 500 that may be within the graphical user interface of the XR environment. The window is defined by a border 510, which may be invisible, colored, or designed in some way to define the outer edges of the window. Within the window there may be a plurality of media content items, illustrated by media content items 520 and 580. These media content items 520 and 580 may be, but are not limited to: images, text, videos, media player interfaces, interactive buttons, or other elements of a graphical user interface. The media content items 520 and 580 may have their own respective levels of visual transparency, or they may share the respective level of transparency of the window 500. The media content items 520 and 580 may further be responsive to the characteristic gaze depth. They may allow for the user to modify a shape, position, contents, or other characteristics of the media content items 520 and 580 within the virtual window 500 based on the characteristic gaze depth and the gaze position data. The virtual window 500 may also include a strong visual cue 560. The strong visual cue 560 may be a distinctive shape overlaid in the center of the virtual window 500. The strong visual cue 560 may also be overlaid in other positions of the window. Further, the strong visual cue 560 may be colored or patterned to create high visual contrast with the window 500 and the media content items 520 and 580. The strong visual cue 560 may also be customizable, and it may also be responsive to the characteristic gaze depth and gaze position data.

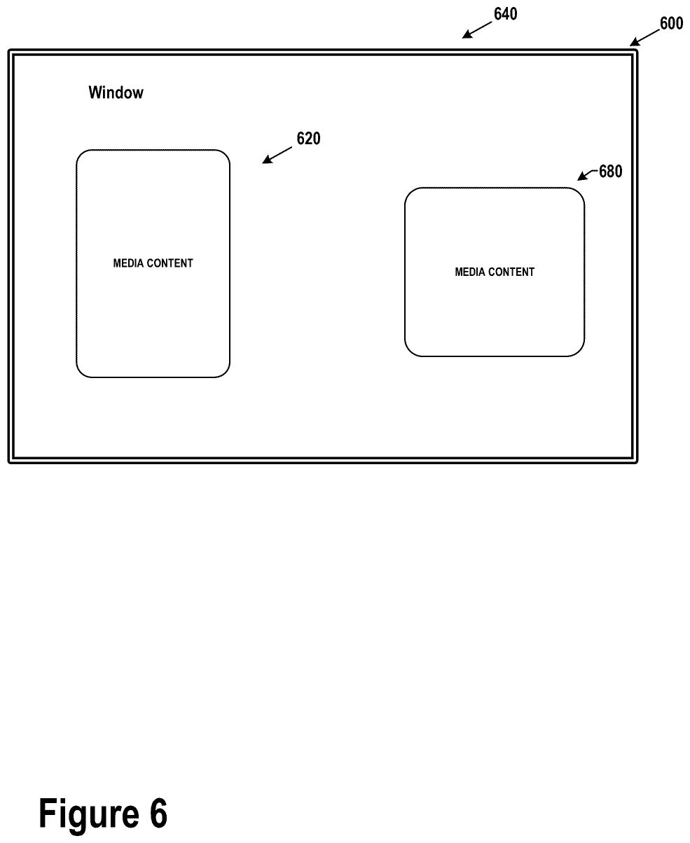

FIG. 6 illustrates an example embodiment of a virtual window 600 that may be within the graphical user interface of the XR environment, which differs from the virtual window 500 illustrated in FIG. 5 in that virtual window 600 lacks a strong visual cue. Instead, the virtual window 600 has a weak visual cue 640. The weak visual cue 640 may be displayed in the margins of the virtual window 600. It may be a colored outline for the window 600 that allows the user to focus on it better. The weak visual cue 640 may also be, but is not limited to: a dotted outline for the window 600, distinctive markings on the corners of the window 600, or patterns on the margins of the window 600. The weak visual cue 640 may also be customizable, and it may also be responsive to the characteristic gaze depth and gaze position data. The weak visual cue 640 may also be changed into a strong visual cue, either by operations performed by the system or responsive to the characteristic gaze depth and gaze position data.

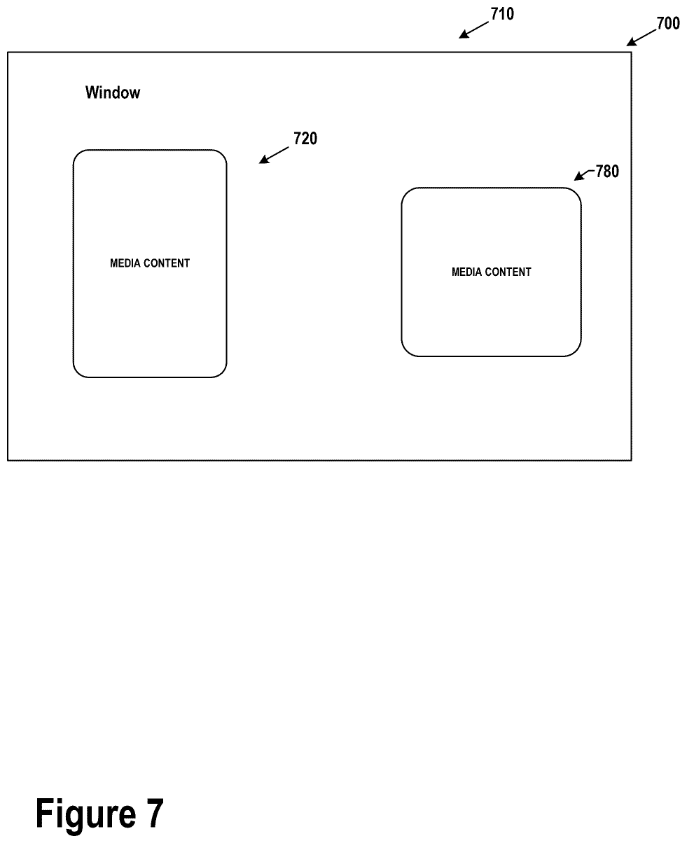

FIG. 7 illustrates an example embodiment of a virtual window 700 that may be within the graphical user interface of the XR environment, which differs from the virtual windows 500 and 600 illustrated in FIGS. 5 and 6 by not displaying a strong or weak visual cue. The window 700 may still have an outline 710, which may have a respective level of visual transparency, and may be invisible. The outline 710 may still be colored or contrasted from the window 700, and may also be responsive to the characteristic gaze depth and the gaze position data.

In some example embodiments, the virtual window may be configured to display at least one visual cue, wherein the visual cue is displayed based on one or more adjustable display settings. A plurality of levels beyond strong and weak may be defined for the visual cue. Additionally, the visual cue may also be customizable by the user or by instructions performed by the system. Further, the visual cue may be customizable according to the training program described in some example embodiments of the present disclosure.

### III. EXAMPLE METHODS

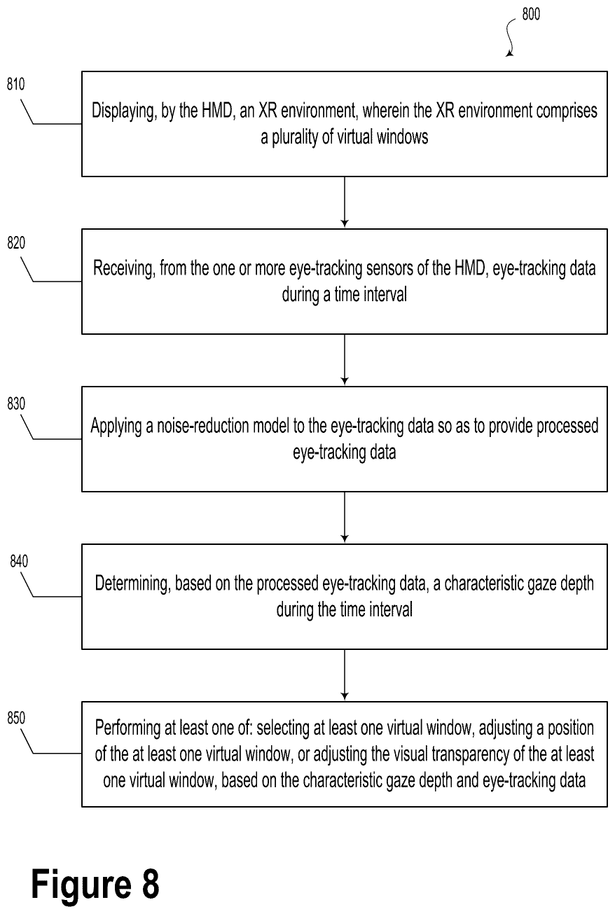

FIG. 8 illustrates an example method 800 of calculating a characteristic gaze depth and facilitating interactions with the XR environment using the characteristic gaze depth. It will be understood that the method 800 may include fewer or more steps or blocks than those expressly illustrated or otherwise disclosed herein. Furthermore, respective steps or blocks of method 800 may be performed in any order and each step or block may be performed one or more times. In some embodiments, some or all of the blocks or steps of method 800 may be carried out by controller 120 and/or other elements of HMD 101 or system 100, as illustrated and described with respect to FIG. 1.

Block 810 of the method includes displaying, by the HMD 101, an XR environment, wherein the XR environment comprises a plurality of virtual windows. Using the one or more eye-tracking sensors of the HMD, method block 820 then receives eye-tracking data during a time-interval. Block 830 includes applying a noise-reduction model to the eye-tracking data so as to provide processed eye-tracking data. Block 840 includes determining, based on the processed eye-tracking data, a characteristic gaze depth during the time interval. Block 850 includes performing at least one of: selecting at least one virtual window, adjusting a position of the at least one virtual window, or adjusting the visual transparency of the at least one virtual window, based on the characteristic gaze depth and eye-tracking data.

The noise-reduction model applied in block 830 may be a machine learning model trained on prior gaze depth data, wherein the prior gaze depth data comprises customized gaze depth data from one or more individuals. These data may be stored locally on the HMD, or in a centralized cloud database. These data may also be sourced from the training methods outlined in some example embodiments of the present disclosure. The noise-reduction model applied in block 830 may also include probabilistic methods of noise reduction.

In some example embodiments, the method 800 illustrated in FIG. 8 may include modifying at least one component of the at least one selected virtual window. Block 850 may include modifying a media content item of the virtual window, selecting a subcomponent, or interacting with a user-interface feature in the selected virtual window. Modifying at least one component of the at least one selected virtual window may be done based on the characteristic gaze depth, the gaze position data, gaze dwell time, blink detection, eyelid openness, verbal commands, physical controllers, gaze convergence, or other data.

Some example embodiments of the method 800 illustrated in FIG. 8 include activating a detail layer in the at least one selected virtual window based on the characteristic gaze depth. The detail layer may include additional information or media content associated with a component of the virtual window that is activated and displayed based on the characteristic gaze depth. The detail layer may have its own respective level of visual transparency, or it may have a level of visual transparency based on the level of visual transparency of one of the one or more virtual windows. In some embodiments, the activation of a detail layer may include creating a new virtual window that may be interacted with and manipulated based on the characteristic gaze depth.

In some embodiments, activating the detail layer may include displaying at least one visual cue. This visual cue may be a strong cue, a weak cue, or another type of visual cue. It may be displayed in the detail layer itself, or in the associated selected virtual window.

In a further embodiment, activating the detail layer may include displaying, by the HMD, an expanded view of the at least one selected virtual window, and adjusting the level of visual transparency of the selected virtual window. The expanded view may include additional information about certain components of the selected virtual window. It may also include media content, interactive elements, or other components. In some embodiments, the expanded view may also be selected and a further detail layer be activated and displayed. This further detail layer may also include a further expanded view.

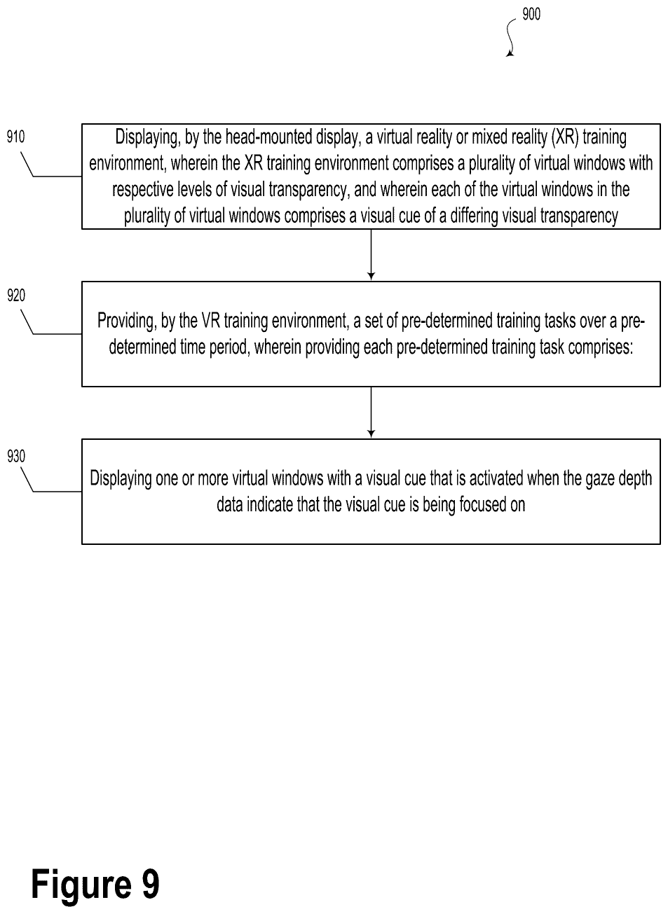

FIG. 9 illustrates an example method 900 of training a user to use the characteristic gaze depth within the XR environment. It will be understood that the method 900 may include fewer or more steps or blocks than those expressly illustrated or otherwise disclosed herein. Furthermore, respective steps or blocks of method 900 may be performed in any order and each step or block may be performed one or more times. In some embodiments, some or all of the blocks or steps of method 900 may be carried out by controller 120 and/or other elements of system 100 or HMD 101, as illustrated and described with respect to FIG. 1.

Block 910 includes displaying, by the head-mounted display, an XR training environment, wherein the XR training environment comprises a plurality of virtual windows with respective levels of visual transparency, and wherein each of the virtual windows in the plurality of virtual windows comprises a visual cue of a differing visual transparency. Block 920 includes providing, by the VR training environment, a set of pre-determined training tasks over a pre-determined time period, wherein providing each pre-determined training task comprises block 930, displaying one or more virtual windows with a visual cue that is activated when the gaze depth data indicate that the visual cue is being focused on. These training tasks help teach a user to focus their eyes to use the characteristic gaze depth to interact with the XR environment. For some users, the action of focusing their eyes without visual cues may be unnatural. Therefore, the training tasks, through the use of differing levels of visual cues and a variety of virtual windows of various respective levels of visual transparency, teach users to change the characteristic gaze depth at will.

Some example embodiments of the method 900 illustrated in FIG. 9 may include providing feedback and performance information on completed training tasks, and adjusting one or more aspects of the training environment based on the feedback and performance information. In an example embodiment, a depth range may be defined for activating the visual cues with different respective levels of visual transparency assigned to the visual cues based on the user's visual depth. This depth range may then be modified until the characteristic gaze depth is within one of the at least one virtual windows. In another example embodiment, the visual cues may be changed in response to user performance on the pre-determined training tasks in block 930. A user with a certain level of success on these tasks may be given weak visual cues instead of strong visual cues earlier in the sequence of training tasks than a user with a lower level of success.

Some example embodiments of the method 900 illustrated in FIG. 9 may include using the feedback and performance information to train a machine-learning model, wherein adjusting the one or more aspects of the training environment is based on the trained machine learning model. Past data, either from the user or from other users, may be used to train this machine learning model. The trained machine learning model may then define new parameters for the pre-determined training tasks, or change the sequence of training tasks. In some embodiments, the trained machine learning model may also change the respective levels of visual transparency of the virtual windows or the visual cues, and it also may change the layout or design of the visual cues.

Some example embodiments of the method 900 illustrated in FIG. 9 may also include using an adaptive learning strategy to determine the pre-determined set of training tasks. The adaptive learning strategy involves activating the visual cue with different transparency indexes assigned to the visual cue based on the user's visual depth. This visual depth may be pre-determined or measured by the one or more eye-tracking sensors. A depth range may be defined based on the user's visual depth, and the depth range may be larger than the confines of the virtual window. The adaptive transparency of the visual cue serves as feedback to the user, allowing them to view in real-time how their characteristic gaze depth is being calculated and helping them to focus their gaze on specific locations and depths in the XR environment. By gradually reducing the depth range of the visual cue, it helps the user to eventually focus their gaze on a specific point or plurality of points that allows for the activation of at least one of the virtual windows.

### IV. CONCLUSION

The above detailed description describes various features and functions of the disclosed systems, devices, and methods with reference to the accompanying figures. In the figures, similar symbols typically identify similar components, unless context indicates otherwise. The illustrative embodiments described in the detailed description, figures, and claims are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flowcharts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium, such as a storage device, including a disk drive, a hard drive, or other storage media.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

We claim:

1. A system comprising:
a controller having a memory; and
program instructions, stored in the memory, that upon execution cause the system to perform operations comprising:
displaying, via a head-mountable display (HMD), a virtual reality or mixed reality (XR) environment, wherein the XR environment comprises a plurality of virtual windows with respective levels of visual transparency that are displayed at respective virtual distances in the XR environment;
receiving, from one or more eye-tracking sensors of the HMD, eye-tracking data during a time interval;
applying a noise-reduction model to the eye-tracking data so as to provide processed eye-tracking data;
determining, based on the processed eye-tracking data, a characteristic gaze depth during the time interval; and
performing at least one of: selecting at least one virtual window, adjusting a position of the at least one virtual window, or adjusting the visual transparency of the at least one virtual window, based on the characteristic gaze depth and eye-tracking data.

2. The system of claim 1, wherein the operations further comprise:
modifying a shape, a position, contents, or other characteristics of the at least one virtual window based on the characteristic gaze depth and gaze position data.

3. The system of claim 1, wherein at least a portion of the controller is disposed within the HMD.

4. The system of claim 1, wherein the noise-reduction model comprises:
a machine learning (ML) model trained on prior gaze depth data, wherein the prior gaze depth data comprises customized gaze depth data from one or more individuals.

5. The system of claim 1, wherein determining the characteristic gaze depth is further based on information indicative of at least one of: gaze dwell time, gaze convergence, eyelid openness, blink detection, verbal commands, or physical controllers.

6. The system of claim 1, wherein the eye-tracking data comprises gaze position data.

7. A method comprising:
displaying, by a head-mountable display (HMD), a virtual reality or mixed reality (XR) environment, wherein the XR environment comprises a plurality of virtual windows with respective levels of visual transparency that are displayed at respective virtual distances in the XR environment;
receiving, from one or more eye-tracking sensors of the HMD, eye-tracking data during a time interval;
applying a noise-reduction model to the eye-tracking data so as to provide processed eye-tracking data;
determining, based on the processed eye-tracking data, a characteristic gaze depth during the time interval; and
performing at least one of: selecting at least one virtual window, adjusting a position of the at least one virtual window, or adjusting the visual transparency of the at least one virtual window, based on the characteristic gaze depth and eye-tracking data.

8. The method of claim 7, wherein the noise-reduction model comprises:
a machine learning (ML) model trained on prior gaze depth data, wherein the prior gaze depth data comprises customized gaze depth data from one or more individuals.

9. The method of claim 7, wherein displaying the XR environment comprises displaying at least one visual cue, wherein the visual cue comprises a strong visual cue, wherein the strong visual cue comprises:
a central visual element with high contrast.

10. The method of claim 7, wherein displaying the XR environment comprises displaying at least one visual cue, wherein the visual cue comprises a weak visual cue, wherein the weak visual cue comprises:
a visual element that is located at a center or along edges of a given virtual window.

11. The method of claim 7, wherein displaying the XR environment comprises displaying at least one visual cue, wherein the visual cue is displayed based on one or more adjustable display settings.

12. The method of claim 7, wherein selecting the at least one virtual window comprises modifying at least one component of the at least one selected virtual window.

13. The method of claim 7, wherein selecting the at least one virtual window comprises activating a detail layer based on the characteristic gaze depth.

14. The method of claim 13, wherein activating the detail layer comprises displaying at least one visual cue.

15. The method of claim 13, wherein activating the detail layer comprises:
displaying, by the HMD, an expanded view of the at least one selected virtual window; and
adjusting the visual transparency of the selected virtual window.

16. The method of claim 7, wherein the eye-tracking data comprises gaze position data.

17. A method comprising:
displaying, by a head-mounted display, a virtual reality or mixed reality (XR) training environment, wherein the XR training environment comprises a plurality of virtual windows with respective levels of visual transparency, and wherein each of the virtual windows in the plurality of virtual windows comprises a visual cue of a differing visual transparency, and
providing, by the XR training environment, a set of pre-determined training tasks over a pre-determined time period, wherein providing each pre-determined training task comprises:
displaying one or more virtual windows with a visual cue that is activated when gaze depth data indicate that the visual cue is being focused on.

18. The method of claim 17, further comprising:
providing feedback and performance information on completed training tasks, and
adjusting one or more aspects of the training environment based on the feedback and performance information.

19. The method of claim 18, wherein the feedback and performance information is used to train a machine-learning (ML) model, wherein adjusting the one or more aspects of the training environment is based on the trained ML model.

20. The method of claim 17, wherein the visual cue has an adaptive level of visual transparency that is based on a pre-determined depth range that is larger than confines of the one or more virtual windows.
